(19) United States
(12) Patent Application Publication
(10) Pub. No.: US 2010/0053772 A1
(43) Pub. Date: Mar. 4, 2010

(54) Lens assembly and manufacturing method of the same

(75) Inventors: Hye Ran Oh, Suwon (KR); In Cheol Chang, Seongnam (KR); Seok Cheon Lee, Suwon (KR); Young Su Jin, Yongin (KR); Cheong Hee Lee, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/318,527

(22) Filed: Dec. 30, 2008

(30) Foreign Application Priority Data
Sep. 1, 2008 (KR) 10-2008-0086053

(51) Int. Cl. G02B 17/00; B29D 11/00

(52) U.S. Cl. 359/736; 264/1.1

(57) ABSTRACT

There is provided a lens assembly including: a first lens part including a first lens surface as an object-side surface, a second lens surface as an image-side surface, and a peripheral part defining a periphery of the second lens surface; a second lens part disposed at an image side of the first lens part and including at least one lens; a spacer spacing the first lens part and the second lens part from each other; and a light adjustor disposed between the second lens surface and the peripheral part, the light adjustor totally reflecting or refracting light incident at a predetermined angle of view or more.

### CROSS-REFERENCE T0 RELATED APPLICATIONS

This application claims the priority of Korean Patent Application No. 2008-0086053 filed on Sep. 1, 2008, in the Korean Intellectual Property Office, the disclosure of which is incorporated herein by reference.

### BACKGROUND OF THE INVENTION

1. Field of the Invention

The present invention relates to a lens assembly and a method of manufacturing the lens assembly, and more particularly, to a lens assembly in which a plurality of lenses are assembled, and a method of manufacturing the lens assembly.

2. Description of the Related Art

Recently, commercially-popular electronic devices have been reduced in size and weight. Accordingly, this has called for a technology for manufacturing parts mounted in the electronic devices in a smaller size and weight, and at a lower cost.

Notably, a technology for achieving a smaller and lighter personal mobile terminal such as a mobile phone and a personal digital assistant (PDA) is in high demand. This also has led to expansion in the parts market such as a camera module mounted on the mobile phone.

In line with this market demand, a camera module also requires a very compact, light and less-expensive lens assembly. As an appropriate manufacturing method of such a lens assembly, the lens assembly can be obtained by wafer unit.

Assembling the lens by a wafer unit does not involve separate assembling processes, unlike a general injection-molded lens. However, a single lens assembly is formed by bonding a plurality of lenses together. This increases mass producibility of the lens assembly. Moreover, this superior mass producibility advantageously allows the lens assembly to be commercialized at a lower cost.

However, assembling lenses by the wafer unit entails a problem that the lens assembly having the lenses assembled together is degraded in optical properties.

Particularly, the lens assembly may be noticeably degraded in performance due to a flare phenomenon in which a portion of light passing through the lenses is diffuse-reflected and formed like a noise on an imaging surface. Therefore, this problem should be overcome in the lens assembly manufactured by the wafer unit.

### SUMMARY OF THE INVENTION

An aspect of the present invention provides a lens assembly of a lens manufactured as a wafer scale, in which a path of light is appropriately changed by total reflection or refraction so as to prevent a flare- or ghost-causing portion of light incident at a predetermined angle of view or more from reaching an imaging surface, thereby increasing performance of a camera or a camera module employing such a lens assembly.

According to an aspect of the present invention, there is provided a lens assembly including: a first lens part including a first lens surface as an object-side surface, a second lens surface as an image-side surface, and a peripheral part defining a periphery of the second lens surface; a second lens part disposed at an image side of the first lens part and including at least one lens; a spacer spacing the first lens part and the second lens part from each other; and a light adjustor disposed between the second lens surface and the peripheral part, the light adjustor totally reflecting or refracting light incident at a predetermined angle of view or more.

The light adjustor may include at least one adjusting surface, wherein the adjusting surface has an inclination equal to or greater than zero, wherein the inclination of the adjusting surface is a ratio of an absolute value of a length of the adjusting surface in a lens radius direction to a length of the adjusting surface in a lens thickness direction, wherein a direction in which a lens thickness is increasing defines a positive sign and a direction in which a lens thickness is decreasing defines a negative sign.

The light adjustor may include a first adjusting surface and a second adjusting surface sequentially disposed from the second lens surface toward the peripheral part, the light adjustor satisfying following condition:

T1>T2 condition

The light adjustor may include an n number of adjusting surfaces sequentially disposed from the second lens surface toward the peripheral part, the light adjustor satisfying following condition:

T1>T2> . . . >Tn condition,

where n is a natural number, T1 is an inclination of a corresponding one of the adjusting surfaces closest to the second lens surface, T2 is an inclination of a next one of the adjusting surfaces and Tn is an inclination of the nth adjusting surface.

The T1 may be equal to or greater than zero.

The lens assembly may further include a shield disposed on at least one of the plurality of adjusting surfaces to absorb light incident at a predetermined angle of view or more.

According to an aspect of the present invention, there is provided a method of manufacturing a lens assembly, the method including: forming a lens wafer providing a plurality of lenses by forming a plurality of lens surfaces on each of top and bottom surfaces of the lens wafer; forming a light adjustor having at least one adjusting surface formed on an outer periphery of each of the lens surfaces on the bottom surface of the lens wafer, the light adjustor reflecting light incident at a predetermine angle of view or more in a sideward direction; and manufacturing a lens unit by cutting the lens wafer assembled.

The forming a light adjustor may include setting an inclination of the adjusting surface to equal to or greater than zero, wherein the inclination of the adjusting surface is a ratio of an absolute value of a length of the adjusting surface in a lens radius direction to a length of the adjusting surface in a lens thickness direction, wherein a direction in which a lens thickness is increasing defines a positive sign and a direction in which a lens thickness is decreasing defines a negative sign.

The forming a light adjustor may include forming first and second adjusting surfaces sequentially from the lens surface toward an outer periphery to satisfy following condition:

T1>T2 condition

The forming a light adjustor may include forming an n number of adjusting surfaces sequentially from the lens surface toward an outer periphery to satisfy following condition:

T1>T2> . . . >Tn condition,

where n is a natural number, T1 is an inclination of a corresponding one of the adjusting surfaces closest to the second lens surface, T2 is an inclination of a next one of the adjusting surfaces and Tn is an inclination of the nth adjusting surface.

The T1 may be equal to or greater than zero.

The method may further include a shield disposed on at least one of the plurality of adjusting surfaces to absorb light.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view illustrating a lens assembly according to an exemplary embodiment of the invention;

FIG. 2 is a magnified view illustrating an A portion shown in FIG. 1 in more detail;

FIG. 3 illustrates a light adjustor of a lens assembly according to an exemplary embodiment of the invention;

FIG. 4 illustrates a light adjustor of a lens assembly according to another exemplary embodiment of the invention;

FIG. 5 is an optical simulation result of a lens assembly according to the embodiment shown in FIG. 1; and

FIGS. 6A to 6C are a schematic view illustrating a method of manufacturing a lens assembly according to an exemplary embodiment of the invention.

### DETAILED DESCRIPTION OF THE PREFERRED EMBODIMENT

Exemplary embodiments of the present invention will now be described in detail with reference to the accompanying drawings.

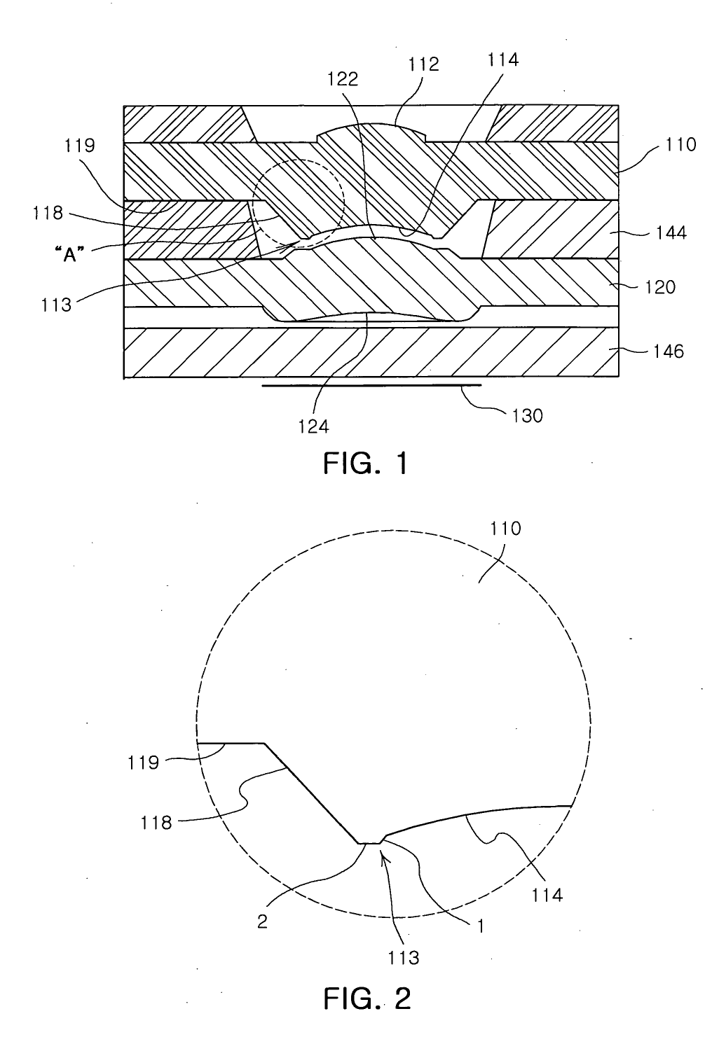

First, a lens assembly according to an exemplary embodiment of the invention will be described with reference to FIG. 1. FIG. 1 is a cross-sectional view illustrating a lens assembly according to an exemplary embodiment of the invention. As shown in FIG. 1, the lens assembly of the present embodiment includes a first lens part 110, a second lens part 120, an imaging surface 130 and a spacer 144.

The first lens part 110 includes a first lens surface 112, a second lens surface 114 and peripheral parts 118 and 119. The first lens part 110 is fabricated by cutting one lens element from a wafer lens having a plurality of lens elements connected.

The first lens surface 112 is formed at an object-side surface of the first lens part 110 and is a surface where light passing through an opening of the lens assembly enters first. The second lens surface 114 is formed at an image-side surface of the first lens part 110 and is a surface where light passing through the first lens surface 112 propagates toward the second lens part 120 through the first lens part 110. The peripheral parts 118 and 119 are formed on an outer peripheral surface of the second lens surface 114. The peripheral parts 118 and 119 include a lens inclined surface 118 and a lens fixed surface 119 formed at an end portion of the lens inclined surface 118.

Here, the lens fixed surface 119 fixes the first lens part 110 in position and is an area where the spacer 144 is located to space the first lens part 110 and the second lens part 120 from each other.

The second lens part 120 is disposed at an image side of the first lens part 110 and the spacer 144 is interposed between the first lens part 110 and the second lens part 120 to space the first and second lens parts 110 and 120 apart from each other. A spacing between the first lens part 110 and the second lens part 120 may be varied according to optical properties.

Referring to FIG. 1, the second lens part 120 is provided in a single number but not limited thereto. The second lens part 120 may be designed to include a plurality of lenses. The second lens part 120 includes a third lens surface 122 as an object-side surface and a fourth lens surface 124 as an image-side surface.

Also, a cover glass 146 is disposed between the second lens part 120 and the imaging surface 130, and may be configured as a filter to block infrared rays from incident light.

The imaging surface 130 denotes a portion of e.g an image sensor where light is imaged.

Meanwhile, as shown in FIG. 1, the first lens part 110 of the lens assembly according to the present embodiment includes a light adjustor 113 provided between the second lens surface 114 and the peripheral part 118.

Here, the light adjustor 113 is inclined at a predetermined angle to totally reflect or refract a portion of the light incident on the first lens part 110 at a predetermined angle of view or more in a sideward direction, i.e., toward the spacer 144, thereby blocking the light from propagating toward the imaging surface 130.

The light adjustor 113 will be described in greater detail with reference to FIGS. 2 to 4.

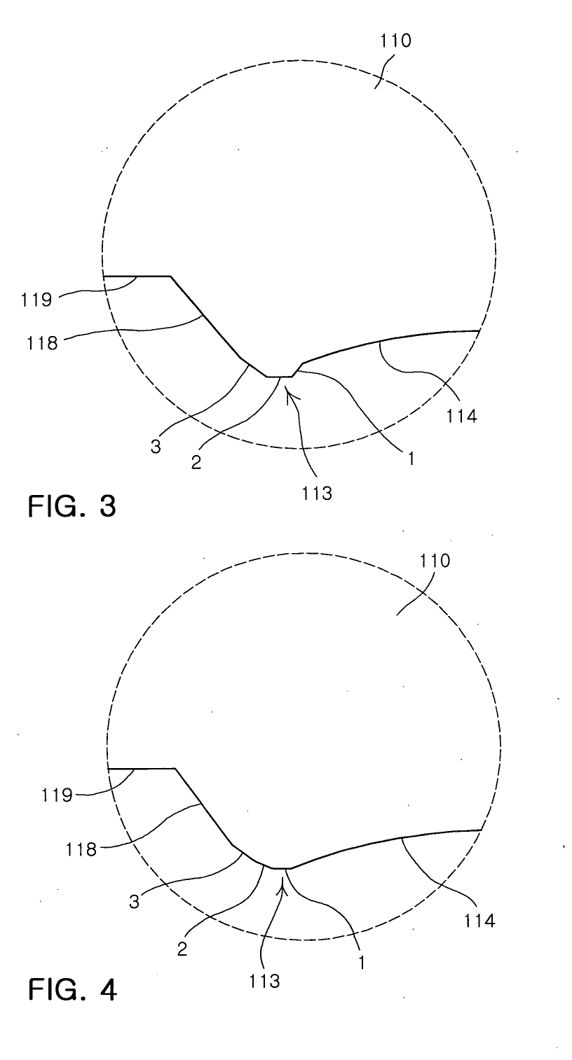

FIG. 2 is a magnified view illustrating an A portion shown in FIG. 1 in more detail. FIG. 3 illustrates a light adjustor of a lens assembly according to an exemplary embodiment of the invention. FIG. 4 illustrates a light adjustor of a lens assembly according to another exemplary embodiment of the invention.

As shown in FIG. 2, the light adjustor 113 of the lens assembly of the present embodiment includes a first adjusting surface 1 and a second adjusting surface 2 sequentially formed from the second lens surface 114 toward the peripheral part 118.

Here, each of the adjusting surfaces has a predetermined inclination. The inclination of the adjusting surface denotes a ratio of an absolute value of a length of the adjusting surface in a lens radius direction to a length of the adjusting surface in a lens thickness direction. A direction in which a lens thickness is increasing defines a positive sign and a direction in which a lens thickness is decreasing defines a negative sign.

That is, a length of the adjusting surface in a vertical or horizontal direction is the inclination of the adjusting surface. The adjusting surface has a positive sign when a lens thickness is increased, i.e., downward in FIG. 2, and a negative sign when a lens thickness is decreased, i.e., upward in FIG. 2.

In the embodiment shown in FIG. 2, an inclination T1 of the first adjusting surface 1 and an inclination T2 of the second adjusting surface 2 satisfy following condition:

T1>T2 condition

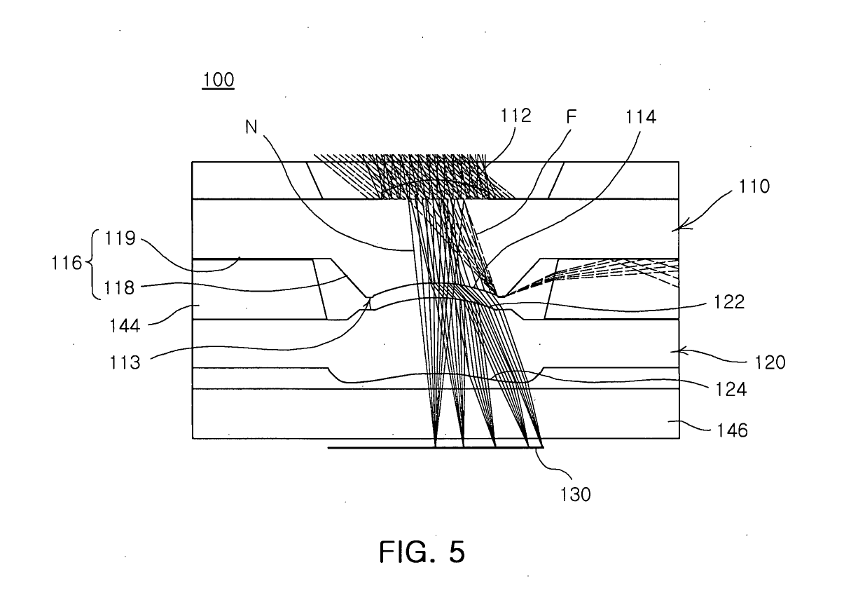

When this condition is satisfied, as shown in FIG. 5, unnecessary flare-causing portion of light, i.e., the portion of light incident at a predetermined angle of view or more, which is designated with F in FIG. 5, is reflected from the light adjustor 113 and travels toward the spacer 144 without propagating to the imaging surface 130. Accordingly, this prevents flare or ghost.

Referring to FIG. 5, N denotes light imaged normally on the imaging surface 130.

Meanwhile, a light adjustor 113 of a lens assembly according to another exemplary embodiment of the invention includes a first adjusting surface 1, a second adjusting surface 2 and a third adjusting surface 3 sequentially disposed from the second lens surface 114 toward a peripheral part 118. Here, an inclination T1 of the first adjusting surface 1, an inclination T2 of the second adjusting surface 2 and an inclination T3 of the third adjusting surface 3 satisfy following condition:

T1>T2>T3 condition

In the present embodiment shown in FIG. 3, the second adjusting surface 2 has an inclination of 0, the first adjusting surface 1 has an inclination greater than zero, and the third adjusting surface 3 has an inclination smaller than zero. That is, the adjusting surface located most adjacent to the second lens surface 114 may have an inclination greater than zero, or have an inclination of at least zero because this allows a flare-causing portion of light to be totally reflected or refracted toward the spacer 144.

FIG. 4 illustrates a case where a first adjusting surface 1, which is the adjusting surface most adjacent to the second lens surface 114 has an inclination T1 of zero and adjusting surfaces 2 and 3 have inclinations decreased with greater proximity to the peripheral part 118.

From the embodiments shown in FIGS. 2 to 4, the light adjustor includes an n number of adjusting surfaces. Also, when the adjusting surfaces have an inclination of T1, T2 . . . Tn, sequentially from the second lens surface 114 to the peripheral part 118, the lens may be formed to satisfy following condition:

T1>T2> . . . >Tn condition

Meanwhile, even though not illustrated, in the present embodiments shown in FIGS. 2 to 4, a shield may be formed on at least one of the adjusting surfaces constituting the light adjustor 113 to absorb and block the flare-causing portion of light.

Here, the shield may be made of a light absorbing material, for example, a photo resist (PR)-coated black material.

Hereinafter, a method of manufacturing a lens assembly according to an exemplary embodiment of the invention will be described.

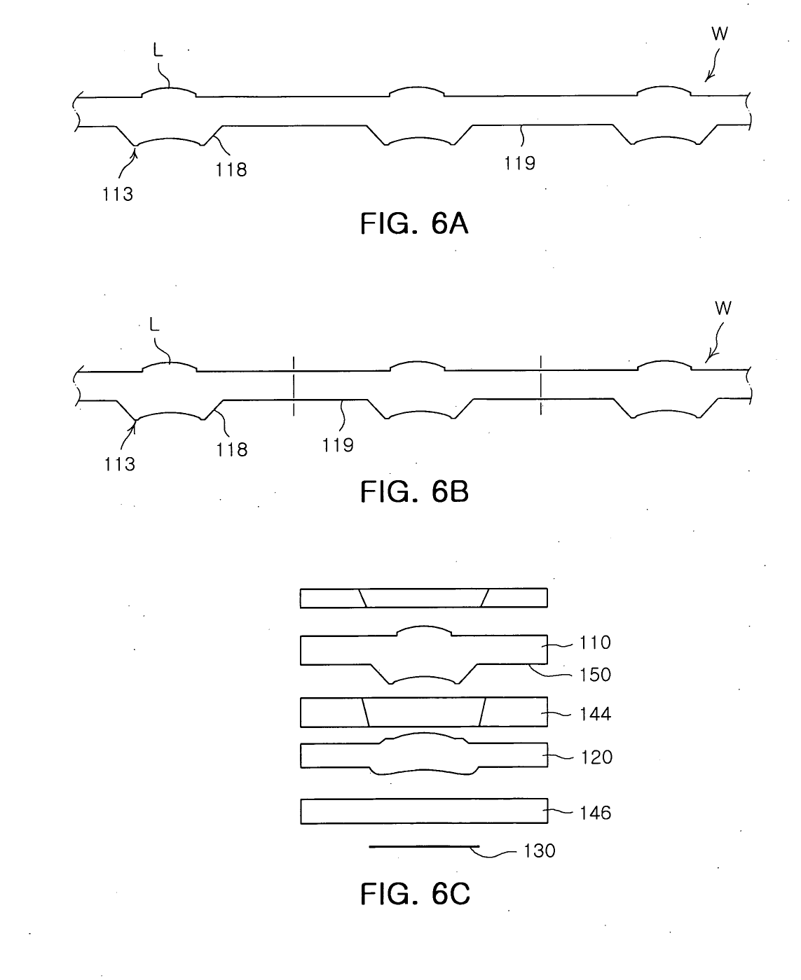

As shown in FIG. 6A, lenses of the lens assembly of the present embodiment are manufactured through a lens wafer W.

That is, a plurality of the lenses L are formed in the lens wafer W and a light adjustor 113 is formed on a rear side of each of the lenses L as shown in FIGS. 1 to 4.

Moreover, as shown in FIG. 6B, the each lens L is cut from the lens wafer W and, as shown in FIG. 6C, the lenses are assembled as a wafer unit and then the lens wafer assembled are cut into a unit.

As described above, the lenses are fabricated by a wafer scale and the light adjustors are formed on a bottom of the lens wafer thereby to mass produce the lenses including the light adjustors shown in FIGS. 1 to 4. Accordingly, this enhances mass producibility.

Here, each of the light adjustors includes all adjusting surfaces each satisfying the condition of the light adjustor described with reference to FIGS. 1 to 4. Also, the shield is formed on at least one of the adjusting surfaces by a wafer scale process, as shown in FIG. 6, thereby increasing mass producibility and quality as well.

In forming the shield, it may be very hard to dispose the shield on only one of the adjusting surfaces out of the plurality of reflecting surfaces constituting the light adjustor.

Therefore, when forming the lens by the wafer scale, the shield may be coated at one time on all of the light adjustors on a bottom surface of the lens wafer.

As set forth above, according to exemplary embodiments of the invention, in a lens assembly of a lens fabricated by a wafer scale, a flare-or-ghost causing portion of light, i.e., the portion of light incident at a predetermined angle of view or more is appropriately totally reflected or refracted not to reach an imaging surface. This ensures a camera or camera module employing the lens assembly to be improved in performance.

While the present invention has been shown and described in connection with the exemplary embodiments, it will be apparent to those skilled in the art that modifications and variations can be made without departing from the spirit and scope of the invention as defined by the appended claims.

What is claimed is:

1. A lens assembly comprising:
a first lens part including a first lens surface as an object-side surface, a second lens surface as an image-side surface, and a peripheral part defining a periphery of the second lens surface;
a second lens part disposed at an image side of the first lens part and including at least one lens;
a spacer spacing the first lens part and the second lens part from each other; and
a light adjustor disposed between the second lens surface and the peripheral part, the light adjustor totally reflecting or refracting light incident at a predetermined angle of view or more.

2. The lens assembly of claim 1, wherein the light adjustor comprises at least one adjusting surface, wherein the adjusting surface has an inclination equal to or greater than zero,
wherein the inclination of the adjusting surface is a ratio of an absolute value of a length of the adjusting surface in a lens radius direction to a length of the adjusting surface in a lens thickness direction,
wherein a direction in which a lens thickness is increasing defines a positive sign and a direction in which a lens thickness is decreasing defines a negative sign.

3. The lens assembly of claim 1, wherein the light adjustor comprises a first adjusting surface and a second adjusting surface sequentially disposed from the second lens surface toward the peripheral part, the light adjustor satisfying following condition:
T1>T2 condition,
where T1 is an inclination of the first adjusting surface and T2 is an inclination of the second adjusting surface,
wherein the inclination of the adjusting surface is a ratio of an absolute value of a length of the adjusting surface in a lens radius direction to a length of the adjusting surface in a lens thickness direction,
wherein a direction in which a lens thickness is increasing defines a positive sign and a direction in which a lens thickness is decreasing defines a negative sign.

4. The lens assembly of claim 3, wherein the T1 is equal to or greater than zero.

5. The lens assembly of claim 3, further comprising a shield disposed on at least one of the plurality of adjusting surfaces to absorb light incident at a predetermined angle of view or more.

6. The lens assembly of claim 1, wherein the light adjustor comprises an n number of adjusting surfaces sequentially disposed from the second lens surface toward the peripheral part, the light adjustor satisfying following condition:
T1>T2> . . . >Tn condition,
where n is a natural number, T1 is an inclination of a corresponding one of the adjusting surfaces closest to the second lens surface, T2 is an inclination of a next one of the adjusting surfaces and Tn is an inclination of the nth adjusting surface,
wherein the inclination of the adjusting surface is a ratio of an absolute value of a length of the adjusting surface in a lens radius direction to a length of the adjusting surface in a lens thickness direction,
wherein a direction in which a lens thickness is increasing defines a positive sign and a direction in which a lens thickness is decreasing defines a negative sign.

7. The lens assembly of claim 6, wherein the T1 is equal to or greater than zero.

8. The lens assembly of claim 6, further comprising a shield disposed on at least one of the plurality of adjusting surfaces to absorb light incident at a predetermined angle of view or more.

9. A method of manufacturing a lens assembly, the method comprising:
forming a lens wafer providing a plurality of lenses by forming a plurality of lens surfaces on each of top and bottom surfaces of the lens wafer;
forming a light adjustor having at least one adjusting surface formed on an outer periphery of each of the lens surfaces on the bottom surface of the lens wafer, the light adjustor reflecting light incident at a predetermine angle of view or more in a sideward direction; and
manufacturing a lens unit by cutting the lens wafer assembled.

10. The method of claim 9, wherein the forming a light adjustor comprises setting an inclination of the adjusting surface to equal to or greater than zero,
wherein the inclination of the adjusting surface is a ratio of an absolute value of a length of the adjusting surface in a lens radius direction to a length of the adjusting surface in a lens thickness direction,
wherein a direction in which a lens thickness is increasing defines a positive sign and a direction in which a lens thickness is decreasing defines a negative sign.

11. The method of claim 9, wherein the forming a light adjustor comprises forming first and second adjusting surfaces sequentially from the lens surface toward an outer periphery to satisfy following condition:
T1>T2 condition,
where T1 is an inclination of the first adjusting surface and T2 is an inclination of the second adjusting surface,
wherein the inclination of the adjusting surface is a ratio of an absolute value of a length of the adjusting surface in a lens radius direction to a length of the adjusting surface in a lens thickness direction,
wherein a direction in which a lens thickness is increasing defines a positive sign and a direction in which a lens thickness is decreasing defines a negative sign.

12. The method of claim 11, wherein the T1 is equal to or greater than zero.

13. The method of claim 11, further comprising a shield disposed on at least one of the plurality of adjusting surfaces to absorb light.

14. The method of claim 9, wherein the forming a light adjustor comprises forming an n number of adjusting surfaces sequentially from the lens surface toward an outer periphery to satisfy following condition:
T1>T2> . . . >Tn condition,
where n is a natural number, T1 is an inclination of a corresponding one of the adjusting surfaces closest to the second lens surface, T2 is an inclination of a next one of the adjusting surfaces and Tn is an inclination of the nth adjusting surface,
wherein the inclination of the adjusting surface is a ratio of an absolute value of a length of the adjusting surface in a lens radius direction to a length of the adjusting surface in a lens thickness direction,
wherein a direction in which a lens thickness is increasing defines a positive sign and a direction in which a lens thickness is decreasing defines a negative sign.

15. The method of claim 14, wherein the T1 is equal to or greater than zero.

16. The method of claim 14, further comprising a shield disposed on at least one of the plurality of adjusting surfaces to absorb light.
